(19) United States
(12) Patent Application Publication
(10) Pub. No.: US 2003/0120563 A1
(43) Pub. Date: Jun. 26, 2003

(54) Method of managing inventory

(76) Inventor: Douglas C. Meyer, Morton, IL (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/027,032

(22) Filed: Dec. 20, 2001

(51) Int. Cl. G06F 17/60

(52) U.S. Cl. 705/28

(57) ABSTRACT

A method improves inventory records at a facility. The method includes the steps of assessing a plurality of current inventory records at the facility, responsively identifying at least one discrepancy in the current inventory records. resolving the at least one discrepancy, identifying at least one deficiency in the current inventory records which resulted in the at least one discrepancy, and establishing a plan to correct the at least one deficiency. The plan includes specific changes to current inventory practices.

### TECHNICAL FIELD

The present invention relates generally to a method for managing inventory at a facility, and more particularly, to a method for maintaining and enhancing the accuracy of inventory records.

### BACKGROUND

Records management may include the process of attempting to maintain or enhance inventory record accuracy levels. Some previous systems used to maintain inventory record accuracy may utilize complete physical inventory counts and perpetual cycle counts. However, complete physical inventory counts disrupt business operations, adversely affect customer service, require a large amount of resources (less than physical inventory counts) and also do not achieve the desired accuracy. Inaccurate inventory records are costly and lead to lost or misplaced inventory.

Additionally, past record management improvement processes identified discrepancies between inventory records and actual inventory levels. Past processes focused on simply adjusting the inventory records to match the actual inventory levels and not on fixing the underlying problems and issues which lead to discrepancies.

The present invention is aimed at overcoming one or more of the problems set forth above.

### SUMMARY OF THE INVENTION

In one aspect of the present invention, a method of improving inventory records at a facility, is provided. The method includes the steps of assessing a plurality of current inventory records at the facility, responsively identifying at least one discrepancy in the current inventory records, identifying at least one deficiency in the current inventory records which resulted in the at least one discrepancy, and establishing a plan to correct the at least one deficiency.

In another aspect of the present invention, a method of improving records of inventory at a facility is provided. The method includes the steps of assessing a plurality of current inventory records at the facility using a statistical test count process, delivering awareness training to managers of the facility, delivering awareness training to employees of the facility, delivering stock count coordinator training to stock count coordinators, and performing location audits at predetermined locations.

In still another aspect of the present invention, a method of improving records of inventory at a facility, is provided. The method includes the steps of stabilizing current inventory recording processes, assessing current inventory recording processes, and improving the current inventory recording processes as a function of the assessment.

### BRIEF DESCRIPTION OF THE DRAWINGS

FIG. 1 is flow diagram of a process for managing inventory at a facility, according to an embodiment of the present invention;

FIG. 2 is flow diagram of a process for managing inventory at a facility, according to another embodiment of the present invention;

FIG. 3 is flow diagram of a process for managing inventory at a facility, according to still another embodiment of the present invention;

FIG. 4 is a portion of a chart illustrating the schedule for a first phase of an exemplary application of the present invention;

FIG. 5 is a portion of a second chart illustrating the schedule for a second phase of the exemplary application of the present invention; and,

FIG. 6 is a third chart illustrating the schedule for a third phase of the exemplary application of the present invention.

### DETAILED DESCRIPTION

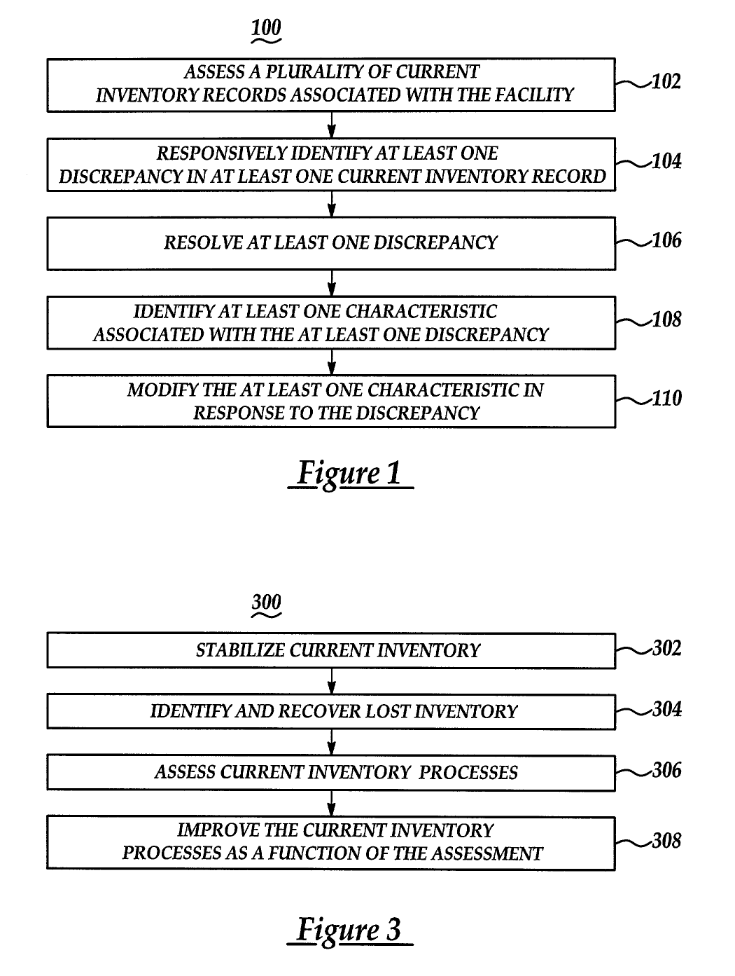

With reference to FIGS. 1-3 of the drawings and in operation, the present invention provides a method 100, 200, 300 for improving records of inventory at a facility. In one aspect of the present invention, the method is applied to the record keeping processes of a facility by consultants, external to owners of the facility. In another aspect of the present invention, the method is applied by employees of the facility owners. The method 100, 200, 300 of the present invention is applied in response to inaccuracies caused by problems within the current record keeping processes and/or a desire to improve current inventory practices. In the below discussion, “consultants” refers to the groups of individuals who are performing the record improving method, whether outside consultants or employees of the facilities.

With specific reference to FIG. 1, a method 100 for improving the records of inventory at a facility (not shown), according to one aspect of the present invention will now be described.

In a first process block 102, a plurality of current inventory records associated with the facility are assessed. In a second process block 104, at least one discrepancy in at least one of the current inventory records is identified in response to the assessment.

In a third process block 106, the at least one discrepancy is resolved. For example, an assessment of an inventory record may indicate that there are N parts of type “X” located in a storage bin. However, there are only n actually located within the bin. The discrepancy may be resolved by either finding the missing or misplaced parts or adjusting the count in the record to match the number of parts found in the bin (e.g., due to a paper or record keeping error).

In a fourth process block 108, at least one characteristic of the at least one of the current inventory records which resulted in the at least one discrepancy is identified.

In a fifth process block 110, the at least one characteristic of the at least one of the current inventory records is modified in response to the characteristic. In one embodiment, the step of modifying the at least one characteristic may include adjusting and/or modifying the at least one characteristic to the current inventory record.

In another embodiment, the step of identifying the at least one characteristic includes the steps of identifying at least one deficiency in the current inventory records and establishing a plan to correct the at least one deficiency. The plan may include specific changes to current inventory practices, i.e., improving inventory practices or methods. It should be noted that a facility may not have any inventory processes. In which case, changes to current inventory practices will include the addition of inventory processes. Continuing with the above example, a number of parts of type X were removed from the storage bin and temporarily and improperly stored elsewhere prior to use. The plan may include specific changes to current inventory practices which are aimed at correcting the deficiency. For example, the missing parts are returned to the storage bin and the improper practice stopped.

In one embodiment, the present invention includes establishing desired inventory practices, establishing desired performance metrics associated with the inventory practices, and then measuring performance against the desired performance metrics. The difference between the actual performance and the desired performance metrics may be used to identify areas for further improvement in the inventory processes and/or establish modifications to the processes in response to the performance comparisons.

In one embodiment of the present invention, the step of assessing current inventory records includes the step of reviewing an inventory process of the facility, for example, a receiving process. A receiving process is the method and process steps used when inventory is received at the facility.

In one embodiment of the present invention, the step of assessing current inventory records includes the step of performing an audit at a location, e.g., a warehouse, a storage bin, a carousal, etc.

In another embodiment, the step of assessing current inventory records includes the step of performing a statistical test count. The statistical test count is a process designed to assess the current inventory records (for accuracy) without having to do a complete physical count of all the inventory.

In one embodiment, the step of performing a statistical test count includes the step of defining a population of inventory items to count. The population of inventory items to count is less than a total number of inventory items. The statistical test count also includes the steps of counting the population of inventory items, comparing the count with an inventory record, and extrapolating the comparison to the total number of inventory items to achieve an inventory count. The statistical test count is used to determine at a single point in time, the accuracy of the inventory records.

The inventory may be organized using a classification/stratification program. Parts or inventory items are randomly selected for inclusion in the population of inventory items to count. As discussed above, the results of the count of the population of inventory items to count are extrapolated across the total number of inventory items. The count of the included inventory items is performed at various times, either periodically or randomly. Any parts which adversely affected overall results are identified. A causal factor analysis may be performed on these individual parts.

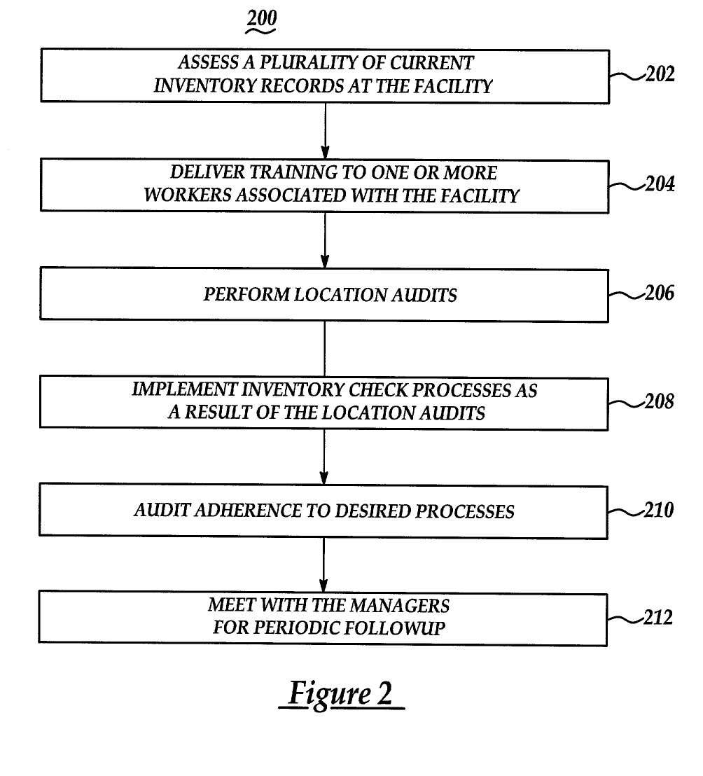

With specific reference to FIG. 2, in another embodiment of the present invention a method 200 improves records of inventory at a facility. In one aspect of the present invention, the method 200 is applied to the record keeping processes at the facility or facilities.

In a first process block 202, a plurality of current inventory records at the facility are assessed using a statistical test count process. As described above, the statistical test count process is designed to assess the current inventory records for accuracy without requiring a complete physical count of all the inventory.

In a second process block 204, training is delivered to one or more workers associated with the facility. In one embodiment, one or more of the following types of training is delivered:

1. awareness training to managers of the facility.

2. awareness training to employees of the facility

3. stock count coordinator training to stock count coordinators.

The awareness training includes training on the appropriate training for the target managers/employees on the processes and methods they perform in their job functions which affect inventory records.

In a third process block 206, location audits are performed. In one embodiment, the location audits are performed at predetermined locations.

Locations include, but are not limited to warehouses, storage rooms, racks, bins, carousals, etc. . . .

In a fourth process block 208, inventory check processes are implemented as a result of the location audits. For example, a process is implemented in which inventory is counted and checked at locations where the location audits indicate a problem.

In a fifth process block 210, adherence to desired processes is audited. In this step, the consultants monitor whether current inventory processes or instructions and the check processes implemented in the fourth process block 208 are being followed.

In an sixth process block 212, the consultants meet with the managers for periodic followup. In one embodiment, the step of meeting with the managers for periodic followup occurs on a daily basis.

In another embodiment, the step of meeting with the managers for periodic following includes the steps of presenting results of the adherence audits, determining re-training needs, reviewing goals, and performing an analysis of areas within the facility at below than acceptable standards.

With specific reference to FIG. 3, in still another embodiment of the present invention, a method 300 improves records of inventory associated with a facility. In one aspect of the present invention, the method is applied to the record keeping processes at the facility or facilities.

In a first process block 302, inventory is stabilized. In a second process block 304 lost or misplaced inventory is identified and recovered. In a third process block 306, current inventory processes are assessed. In a fourth process block 30, the current inventory processes are improved as a function of the assessment.

In one embodiment, the step of stabilizing current inventory processes includes the step of identifying problems and/or (associated) processes contributing to inventory recording problems.

In one embodiment, the step of improving inventory recording processes includes the steps of minimizing the effect of identified problems and contributing processes. In another embodiment, the step of improving current inventory processes may include modifying existing inventory process, adding inventory processes (where none or a limited number exist), and/or modofying and adding inventory processes.

In one embodiment, the step of stabilizing current inventory recording processes further includes the step of fixing the at least one factor. In one embodiment, the step of improving current inventory recording processes includes the steps of minimizing reducing the effect of the factor. The factor may include problems contributing to inventory recording problems and/or processes contributing to inventory recording problems.

In a still further aspect of the present invention, the inventory records are used to assess the validity of claims made against the facility. The claims may be associated with an external party. The external may be either a supplier, e.g., the supplier claims that X number of parts were shipped to the facility while the inventory records show only Y parts were received (where, Y<X), or a customer of the facility, e.g., the customer claims that only A parts were received while the inventory records show that B parts were shipped (where B>A). The claim is then analyzed in view of a characteristic of the inventory. For example, if a specific part is packaged two (2) to a box and the claim is for ½ a shipment, then the claim may be denied because most likely the claimant miscounted. In one embodiment, the claim analysis may be performed in an automated manner. For example, a computer system may be used to review the claims using a software claim analysis function. For example, a claim may be received electronically from an external party. The claim may be automatically compared against stored records (e.g., correlated by a purchase or shipment identifier). The computer system may establish a cause, or perceived cause, for the claim. For example, as indicated above, the claim was related to a shipment of 15 packages having two parts apiece (total of 30 parts shipped), and the claim is for 15 parts because only 15 parts were received (according to claim), the system would reject the claim. The system would reject the claim, for example, because the most likely problem is that the receiver did not properly count the parts, i.e., the packages were counted instead of the parts. In this scenario, the system may reject the claim and may provide a reason for the rejection. In one embodiment, the rejection may be electronically communicated to the receiver by the system. For example, the system may send the receiver a notification of the rejection, and a request to recount the parts due to the perceived problem that the parts were miscounted.

In another embodiment, a claim may be received indicating that the wrong part was shipped, and providing an identifier associated with the part that was allegedly shipped. The system may analyze the inventory location of the part that was to be shipped and the part that allegedly was shipped. If the two are located closely together, the system may recommend claim acceptance. The rationale being that since the parts are very closely located, the wrong part was probably picked for shipment. This information may be stored and/or analyzed for later use in determining how to locate parts in a desired manner. For example, the system may be able to indicate which parts are often being confused with each other, indicating the part bins should be located further away from each other for example. This information may also be used to identify problem prone parts. Problem prone parts may be parts that repeatedly have associated discrepancies. The discrepancies may include inventory record discrepancies or claim discrepancies etc. The analysis may reveal that the part is a theft prone part. Alternatively, the analysis may indicate that the parts bins are improperly or poorly labeled. In addition, the analysis may indicated, as stated above, that two particular parts need to be separated further to reduce/eliminate confusion between the parts.

In another example, the characteristic of the inventory is related to the history of claims of the claimant. If the history indicates that the claimant has rarely indicated problems with shipments, or if past problems that did occur were due to shipping issues as opposed to mistakes by the claimant, then the system may give deference to the claim and allow the claim without further analysis. In one embodiment, the cost of the part may also be taken into account. Therefore a weighting equation may be used such that the fewer the number of previous claims (or claims were the claimant made the mistakes), and the lower the cost of the part, the more likely the system will provide automatic (or recommended) approval of the claim. It may cost less to approve the claim than to flush out the details of the claim for resolution, especially given the previous history of the claimant and/or the cost of the part.

In addition, the system may be configured to resolve receipt griefs in an automated manner. For example, if the records indicate that 1000 parts were received in an order, despite having only ordered 100, then the system may notify a user that the likely error was a data entry error. Therefore the recommendation may be to do a second count of the parts to verify the overage, before taking any action. The notification may occur via electronic methods such as e-mail, fax etc, or simply display the issue to the user the next time the user accesses the system.

### INDUSTRIAL APPLICABILITY

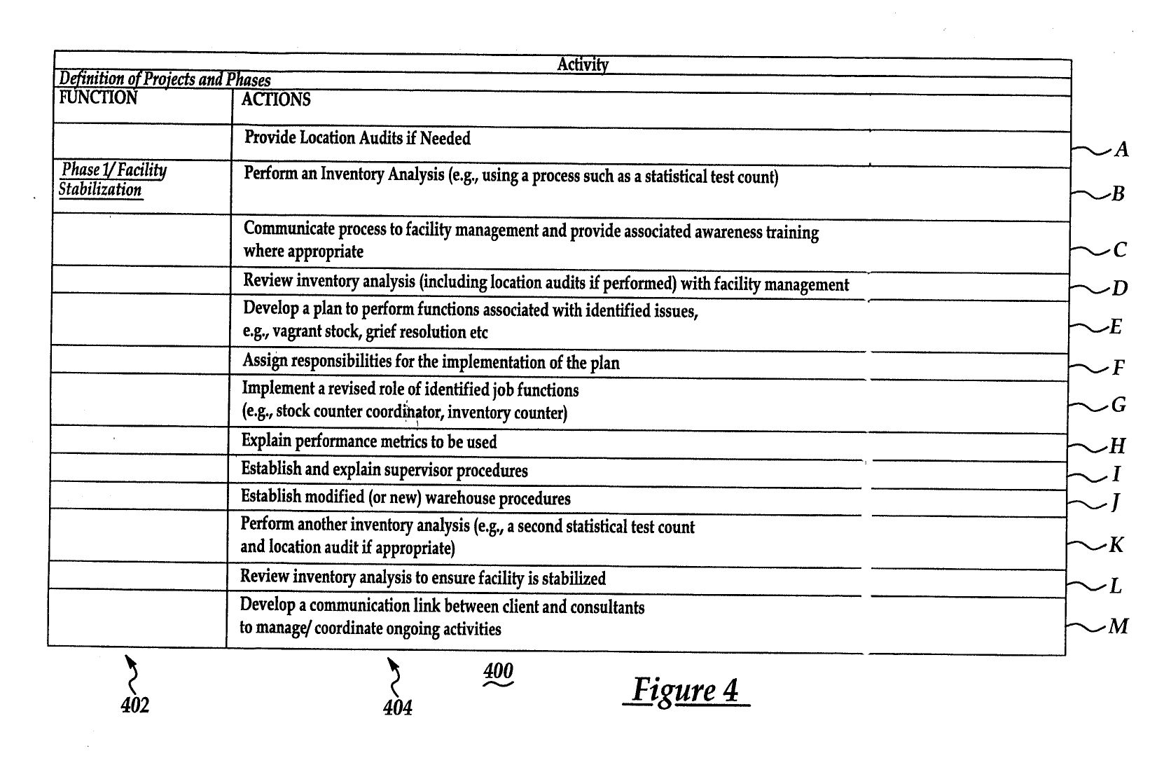

With reference to the drawings and in operation, the present method, is adapted to improve inventory records at a facility. As stated above, the present invention is well adapted to be performed by consultants external to the owners of the facility or at least the management of the facility. However, it should be noted that the present invention may well be adapted to be performed by employees of the facility. For purposes of discussions, consultants will include both outside consultants who have been hired to perform these services or employees of the facilities whose job responsibilities include performing these services. With respect to FIGS. 4-6, the consultants may use a chart or report to track their progress. In the illustrated embodiment, the process is divided into three phases. Phase I is aimed at stabilizing the facility. Phase II is aimed at recovering lost or misplaced inventory. Phase III is aimed at analyzing and reviewing the facility's part system's inventory records and the transition of the work (improving and maintaining the inventory record keeping process) to the client.

A first chart 400, shown in FIG. 4, details Phase I for an exemplary client. The steps that may be included for each Phase are illustrated in a row of the respective chart. For example, the first chart 400 includes rows A through M.

The chart 400 is further divided into first, second, and third columns 402, 404, 406. The first column 402 describes phase being performed. The second column 404 illustrates the actions that may be taken during a Phase.

For example, prior to start of Phase I, the project schedule is agreed upon between the consultant and the client. The action of this step is described in cell 404A. The remaining steps in Phase I are illustrated in rows B-M.

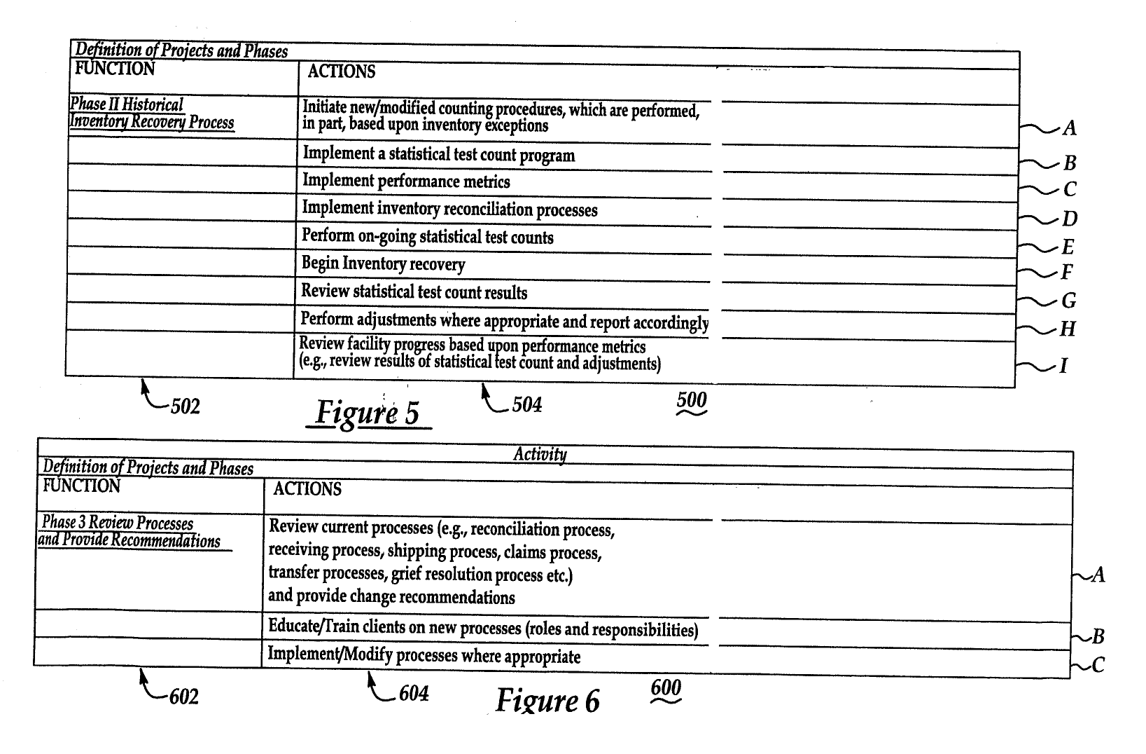

With specific reference to FIG. 5, the steps of Phase II for the exemplary application of the present invention are illustrated in a second chart 500 in which like parts are numbered similarly to FIG. 4. The illustrated Phase II has steps A-I.

With specific reference to FIG. 6, the steps of Phase III for the exemplary application of the present invention are illustrated in a third chart 600 in which like parts are numbered similarly to FIGS. 4 and 5. The steps of Phase III are illustrated in rows A-C.

Other aspects and features of the present invention can be obtained from a study of the drawings, the disclosure, and the appended claims.

What is claimed is:

1. A method of improving records of inventory at a facility, comprising:
assessing a plurality of current inventory records associated with the facility;
responsively identifying at least one discrepancy in at least one of the current inventory records;
resolving the at least one discrepancy;
identifying at least one characteristic associated with the at least one inventory record; and,
modifying the at least one characteristic in response to the discrepancy.

2. A method, as set forth in claim 1, further comprising the steps of:
identifying at least one deficiency in the current inventory records which resulted in the at least one discrepancy; and,
establishing a plan to correct the at least one deficiency, the plan including specific changes to current inventory practices.

3. A method, as set forth in claim 1, wherein the step of modifying the at least one characteristic includes one of adjusting and adding the at least one characteristic to the at least one inventory record.

4. A method, as set forth in claim 1, wherein the step of establishing a plan includes the step of reviewing an inventory process of the facility.

5. A method, as set forth in claim 4, wherein the plan includes the step of improving an inventory practice.

6. A method, as set forth in claim 4, wherein the plan includes the step of improving an inventory methodology.

7. A method, as set forth in claim 4, wherein the inventory process is a receiving process.

8. A method, as set forth in claim 1, wherein the step of assessing current inventory records includes the step of performing a warehouse audit.

9. A method, as set forth in claim 1, wherein the step of assessing current inventory records includes the step of performing a location audit.

10. A method, as set forth in claim 1, wherein the step of assessing current inventory records includes the step of performing a statistical test count.

11. A method, as set forth in claim 10, wherein the step of performing a statistical test count includes the steps of:
defining a population of inventory items to count, the population of inventory items to count being less than a total number of inventory items;
counting the population of inventory items;
comparing the count with an inventory record; and,
extrapolating the comparison to the total number of inventory items to achieve an inventory count.

12. A method of improving records of inventory associated with a facility, comprising:
assessing a plurality of current inventory records at the facility using a statistical test count process;
delivering training to one or more workers associated with the facility;
performing location audits;
implementing inventory check processes as a result of the location audits;
auditing adherence to desired processes; and,
meeting with the managers for periodic followup.

13. A method, as set forth in claim 12, wherein the step of delivering training includes at least one of the steps of:
delivering awareness training to managers of the facility;
delivering awareness training to employees of the facility;
delivering stock count coordinator training to stock count coordinators;

14. A method, as set forth in claim 12, wherein the step of performing location audits is performed at predetermined locations.

15. A method, as set forth in claim 12, wherein the step of meeting with the managers for periodic followup occurs on a daily basis.

16. A method, as set forth in claim 15, wherein the step of meeting with the managers for periodic following includes the steps of:
presenting results of the adherence audits;
determining re-training needs;
reviewing goals; and,
performing an analysis of areas within the facility at below than acceptable standards.

17. A method, as set forth in claim 12, wherein the step of performing a statistical test count includes the steps of:
defining a population of inventory items to count, the population of inventory items to count being less than a total number of inventory items;
counting the population of inventory items;
comparing the count with an inventory record; and,
extrapolating the comparison to the total number of inventory items to achieve an inventory count.

18. A method of improving records of inventory associated with a facility, comprising:
stabilizing current inventory;
identifying and recovering lost inventory; and,
assessing current inventory processes; and,
improving the current inventory processes as a function of the assessment.

19. A method, as set forth in claim 18, wherein the step of assessing current inventory processes includes the step of assessing current inventory recording processes.

20. A method, as set forth in claim 18, wherein the step of improving the current inventory processes includes at least one of the steps of:
modifying existing inventory processes; and, adding inventory processes.

21. A method, as set forth in claim 18, wherein the step of stabilizing current inventory processes includes the step of identifying at least one factor contributing to inventory recording problems.

22. A method, as set forth in claim 21, wherein the step of stabilizing current inventory recording processes further includes the step of fixing the at least one factor.

23. A method, as set forth in claim 18, wherein the step of improving current inventory recording processes includes the steps of reducing the effect of the at least one factor.

24. A method, as set in claim 18, wherein the at least one factor includes problems contributing to inventory recording problems.

25. A method, as set forth in claim 18, wherein the at least one factor includes processes contributing to inventory recording problems.

26. A method, as set forth in claim 18, wherein the at least one factor includes at least one problem and at least one process contributing to inventory recording problems.

27. A method, as set forth in claim 18, wherein the step of improving the current inventory processes includes the steps of:
establishing a desired performance metric associated with at least one of the processes; and
comparing an actual performance with said desired performance metric.

28. A method, as set forth in claim 27, wherein the step of improving the current inventory processes includes the steps of:
modifying at least one process in response to said comparison.

29. A method, as set forth in claim 18, further comprising the step of:
Organizing said inventory using one of a classification process and a stratification process.

30. A method for analyzing claims related to inventory associated with a facility, comprising:
receiving the claim;
analyzing the claim in view of a characteristic of the inventory; and,
accepting or denying the claim based on the analysis of the characteristic.

31. A method, as set forth in claim 30, wherein the claim is associated with an external party and the characteristic of the inventory is associated with the external party.
